(19) United States
(12) Patent Application Publication
(10) Pub. No.: US 2011/0288927 A1
(43) Pub. Date: Nov. 24, 2011

(54) ESTIMATING A DISCOUNTED CUMULATIVE GAIN

(75) Inventors: JEREMY TANTRUM, SHORELINE, WA (US); JUNXIAN WANG, BELLEVUE, WA (US); XIAOLEI LI, KIRKLAND, WA (US)

(73) Assignee: MICROSOFT CORPORATION, REDMOND, WA (US)

(21) Appl. No.: 12/782,899

(22) Filed: May 19, 2010

(51) Int. Cl. G06Q 30/00; G06Q 10/00

(52) U.S. Cl. 705/14.42; 705/14.43

(57) ABSTRACT

Systems, methods, and computer storage media having computer-executable instructions embodied thereon that utilize relevance judgments to estimate a discounted cumulative gain. In embodiments, a query:ad pair including a search query and at least one advertisement is identified. The at least one advertisement is identified as having not been previously associated with the search query and not as not having associated therewith a relevance judgment. An estimated relevance judgment is calculated and utilized to calculate an estimated discounted cumulative gain for the search query.

### BACKGROUND

Relevance of an advertisement related to a particular search query is often identified and utilized such that the most relevant and profitable advertisements are associated with appropriate search queries. Such association between specific advertisements and a particular search query results in a query:ad pair. Each advertisement of a query:ad pair may be associated with a relevance judgment indicating the relevance of the advertisement with respect to the search query.

Advertisement relevance is typically determined during a manual process performed by human editors. The manual process is very expensive and time consuming. For example, a human editor may review a query:ad pair at a rate fewer than 10,000 query:ad pairs per week. Thus, relevance judgments for advertisements are rendered infrequently for a small set of search queries and do not allow for instantaneous evaluation of a query:ad pair's effectiveness.

Discounted cumulative gain (DCG) measures the usefulness, or gain, of an advertisement based on its position in a result list. For example, an advertisement displayed in a prominent position may be assumed to be more relevant than another advertisement displayed in a less prominent position and, thus, may be assumed to be a more useful advertisement. DCG is oftentimes calculated to monitor the effectiveness, or usefulness, of a query:ad pair and evaluate necessary changes to an advertising system. For instance, constant evaluation allows an advertising system to evaluate when query:ad pairs of a search query are not performing optimally and to instantly make adjustments to the advertisements associated with the search query, the position of an advertisement, and the like. A DCG may be thought of as verifying the relevance judgment of an advertisement by calculating the performance of the advertisement.

To calculate the DCG, a relevance judgment of the advertisement is utilized. Given the tedious process of rendering relevance judgments, DCG's are not quickly calculated and may not be available at all for advertisements that have not yet been associated with a relevance judgment. Thus, real-time monitoring of advertising systems by the DCG is not available since the relevance judgment and, thus, the DCG, may not be instantaneously available.

### SUMMARY

Embodiments of the present invention relate to systems, methods, and computer-readable media for, among other things, utilizing a relevance judgment to estimate a discounted cumulative gain. A relevance judgment may be estimated for an advertisement that has not been previously associated with a relevance judgment such that an estimated discounted cumulative gain (eDCG) may be calculated for a search query. An advertisement may be identified as having not been previously associated with a relevance judgment for the query:ad pair. Utilizing an advertiser's history with the search query, the advertiser's history with other search queries, or a history of the search query, an estimated relevance judgment may be identified. The estimated relevance judgment may be utilized to calculate an eDCG for a search query and/or an advertising system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a flow diagram showing a first method for utilizing a relevance judgment to estimate a discounted cumulative gain, in accordance with an embodiment of the present invention;

FIG. 4 is a flow diagram showing a second method for utilizing a relevance judgment to estimate a discounted cumulative gain, in accordance with an embodiment of the present invention; and

FIG. 5 is a flow diagram showing a third method for utilizing a relevance judgment to estimate a discounted cumulative gain, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer storage media having computer-executable instructions embodied thereon that facilitate utilizing a relevance judgment to estimate a discounted cumulative gain. A relevance judgment is a value represented by numerals, symbols, or any other identifying value, that indicates how relevant a particular advertisement is to a particular search query. A discounted cumulative gain (DCG) measures the usefulness, or gain, of an advertisement based on its position in a result list and the relevance judgment. In other words, the DCG verifies a relevance judgment of an advertisement by calculating the performance of the query:ad pair.

A DCG may be utilized to monitor the effectiveness, or usefulness, of a query:ad pair and evaluate necessary changes to an advertising system. For example, constant evaluation of query:ad pair relevance allows an advertising system to evaluate when query:ad pairs of a search query are not performing optimally. The advertising system may instantly make adjustments to the advertisements associated with the search query. However, in order to monitor the DCG, a relevance judgment is identified for each advertisement that is to be evaluated. Some advertisements, for instance, an advertisement that is associated with a search query for the first time, may not yet be associated with a relevance judgment. In that situation, a relevance judgment may be estimated. A resulting estimated relevance judgment may be utilized to calculate an estimated DCG (eDCG).

Accordingly, in one aspect, the present invention is directed to one or more computer storage media having computer-executable instructions embodied thereon, that when executed, cause a computing device to perform a method for utilizing a relevance judgment to estimate a discounted cumulative gain. The method includes identifying a query:ad pair that includes a search query and an advertisement from an advertiser. It is determined that the advertisement is not associated with a relevance judgment and thus, may not have been previously associated with the search query. A relevance judgment is a value representing a relevance of a particular advertisement to a particular search query. An estimated relevance judgment is identified for the advertisement based on a history of the advertiser or a history of the search query. Based on the estimated relevance judgment, an estimated discounted cumulative gain is calculated for the search query.

In another aspect, the present invention is directed a computerized method for utilizing a relevance judgment to estimate a discounted cumulative gain. The method includes identifying a first advertisement associated with a search query. A first relevance judgment is determined to exist for the first advertisement. A second advertisement is identified that is associated with the search query, and it is determined that a second relevance judgment does not exist for the second advertisement. A second relevance judgment is estimated for the second advertisement. A positional weight is identified for each of the first and second advertisements and, based on the position weights and each of the first and second relevance judgments, an estimated discounted cumulative gain is calculated for the search query.

In yet another aspect, the present invention is directed to one or more computer storage media having computer-executable instructions embodied thereon, that when executed, cause a computing device to perform a method for utilizing a relevance judgment to estimate a discounted cumulative gain. The method includes identifying a query:ad pair including a search query and a first advertisement from an advertiser. The first advertisement is identified as having not been previously associated with the search query. It is determined whether the advertiser is associated with a second advertisement that has been associated with the search query. Upon determining that the advertiser is not associated with a second advertisement that has been associated with the search query, it is determined whether the advertiser is associated with a third advertisement that is associated with another search query and has a relevance judgment associated therewith. Upon determining that the advertiser is not associated with a third advertisement that is associated with another search query and has the relevance judgment associated therewith, it is determined if a fourth advertisement from another advertiser is associated with the search query is associated with an alternative relevance judgment. Upon determining that the fourth advertisement from another advertiser is not associated with the search query and is not associated with the alternative relevance judgment, an average of relevance judgments for each advertisement associated having any relevance judgment for any search query is identified. An estimated discounted cumulative gain is calculated using the average of relevance judgments for each advertisement having a relevance judgment that is associated with any search query.

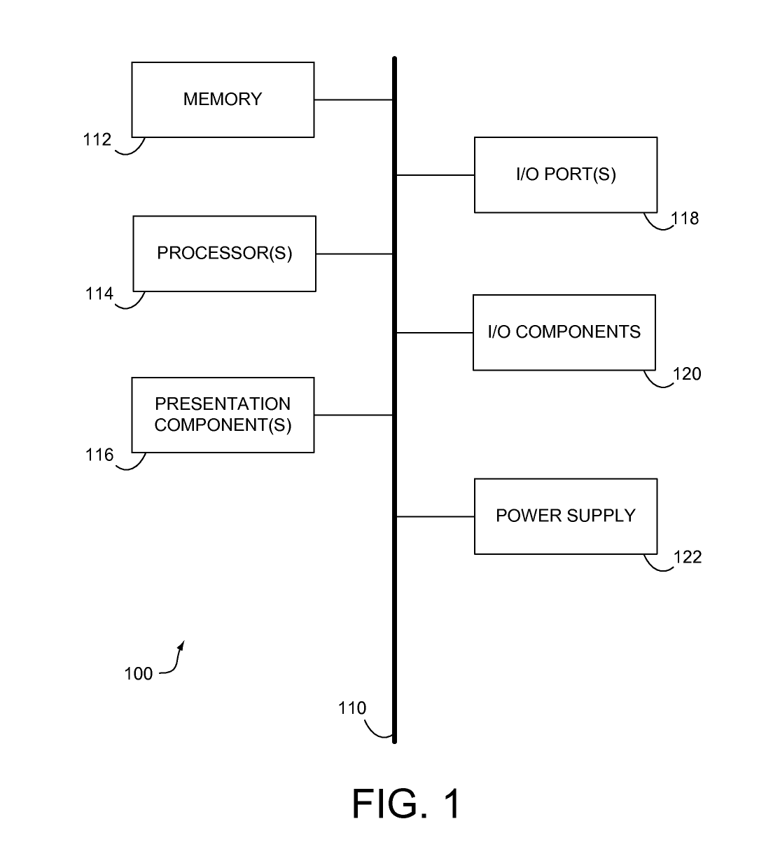

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognizes that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

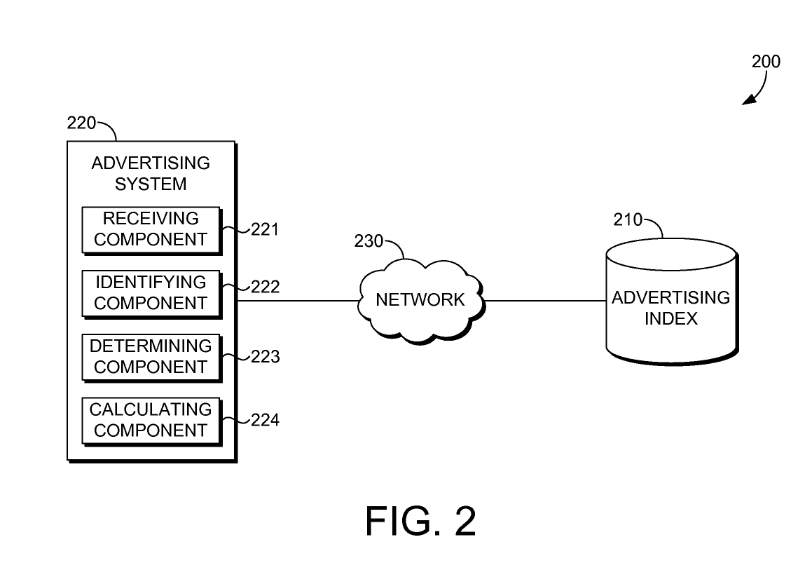

With reference to FIG. 2, a block diagram is illustrated that shows an exemplary computing system architecture 200 configured for use in implementing embodiments of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

Computing system architecture 200 includes an advertising index 210 and an advertising system 220 in communication with one another via a network 230. The network 230 may include, without limitation, one or more local area networks (LANs) and/or wide area networks (WANs). Such networking environments are commonplace in offices, enterprise-wide computer networks, intranets and the Internet. Accordingly, the network 260 is not further described herein.

The advertising index 210 is configured to store information associated with each of relevance judgments, query:ad pairs, positional weights, quality scores, advertisers, and/or advertisement selection. In various embodiments, such information may include, without limitation, search queries, advertisements, query:ad pairs, advertiser information, relevance judgments, and/or the like. In embodiments, the advertising index 210 is configured to be searchable for one or more of the items stored in association therewith. The content and volume of such information stored in association therewith are not intended to limit the scope of embodiments of the present invention in any way. Further, though illustrated as a single, independent component, the advertising index 210 may, in fact, be a plurality of storage devices, for instance a database cluster, portions of which may reside on the advertising system 220, another external computing device (not shown), and/or any combination thereof.

The advertising system 220 shown in FIG. 2 may be any type of computing device, such as, for example, computing device 100 described above with reference to FIG. 1. By way of example only and not limitation, the advertising system 220 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The advertising system 220 may include any type of application server, database server, or file server configurable to perform the methods described herein. Components of the advertising system 220 (not shown for clarity) may include, without limitation, a processing unit, internal system memory, and a suitable system bus for coupling various system components, including one or more databases for storing information (e.g., files and metadata associated therewith). The advertising system 220 typically includes, or has access to, a variety of computer-readable media. By way of example, and not limitation, computer-readable media may include computer-storage media and communication media. In general, communication media enables each server to exchange data via a network, e.g., network 230. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the advertising system 220 is illustrated as a single unit, one skilled in the art will appreciate that the advertising system 220 is scalable. For example, the advertising system 220 may in actuality include a plurality of computing devices and/or servers in communication with one another. Moreover, the advertising index 210 may be included within the advertising system 220. The single unit depictions are meant for clarity, not to limit the scope of embodiments in any form.

As shown in FIG. 2, the advertising system 220 includes a receiving component 221, an identifying component 222, a determining component 223, and a calculating component 224. In some embodiments, one or all of the receiving component 221, the identifying component 222, the determining component 223, or the calculating component 224 may be implemented as stand-alone applications. It will be understood by those of ordinary skill in the art that the receiving component 221, the identifying component 222, the determining component 223, and the calculating component 224 illustrated in FIG. 2 are exemplary in nature and in number and should not be construed as limiting. Any number of components may be employed to achieve the desired functionality within the scope of embodiments hereof.

The components of the advertising system 220 may be used in conjunction with one another to calculate an estimated discounted cumulative gain (eDCG). A discounted cumulative gain (DCG) measures the usefulness, or gain, of an advertisement based on its position in an advertisement display. For example, an advertisement displayed in a prominent position may be assumed to be more relevant than an advertisement displayed in a less prominent position and, thus, may be assumed to be a more useful or effective advertisement. The DCG is monitored to ensure that query:ad pairs yield the most relevant advertisements for the search query of the query:ad pair. DCG's are calculated using relevance judgments of advertisements. Relevance judgments may not always exist for advertisements in query:ad pairs. For example, an advertisement may not yet have been assigned a relevance judgment due to a backlog of the typical manual review process described hereinabove. Thus, the advertising system 220 is configured to calculate an eDCG when relevance judgments are not present for the advertisement by estimating a relevance judgment.

In order to calculate the eDCG, the receiving component 221 may be configured to receive input. As used herein, receiving input may generally refer to receiving, storing, accessing, determining, referencing, and/or the like. Input may include, for example, a search query, an advertisement from an advertiser, a relevance judgment, a quality score, or the like. Typically, an advertisement is received from an advertiser and may be associated with a search query. Such query:ad pairs are generally created to maximize effectiveness of a particular advertisement paired with a particular search query.

The identifying component 222 is configured to identify query:ad pairs that, for example, have been created from the input received by the receiving component 221. The query:ad pair may include a search query and at least one advertisement. In embodiments, a search query is associated with a plurality of query:ad pairs (e.g., query:ad pair A may include at least one advertisement that is associated with the search query and query:ad pair B may also include at least one advertisement that is associated with the search query). In other embodiments, a search query is associated with a single query:ad pair that includes a plurality of advertisements associated with the search query (e.g., query:ad pair C may include a advertisement 1, advertisement 2, and advertisement 3 that are each associated with the search query).

The identifying component 222 may also identify any information related to the query:ad pair(s). The related information may be identified from the advertising index 210, an internal storage device of the identifying component 222, an internal storage device of the advertising system 220, or the like. The related information may include, for example, a relevance judgment of each of the advertisements, an advertiser associated with each advertisement, and the like. It should be noted that the functionality of the identifying component 222 may be performed prior to the functionality of the determining component 223, subsequent to the functionality of the determining component 223, and/or in cooperation with the determining component 223.

The determining component 223 is configured to determine whether a relevance judgment exists for a particular advertisement identified of the query:ad pair. Relevance judgments may exist for an advertisement in the query:ad pair if the advertisement has been previously associated with the search query. In that situation, the advertisement has already undergone analysis to determine how relevant it is to the search query of the query:ad pair and, thus, has already been associated with a relevance judgment. Relevance judgments that are preexisting for advertisements may be considered to be the most reliable relevance judgments since they illustrate an accurate assessment of the relevancy of the advertisement with respect to the search query at issue.

A relevance judgment that is preexisting for an advertisement may be designated as a reliable relevance judgment by associating the advertisement with a quality score. A quality score is a value that illustrates a reliability of the relevance judgment associated with an advertisement. In the above situation where an advertisement has been previously associated with a particular search query and, thus, has an existing, or actual, relevance judgment, a highest quality score may be associated with the relevance judgment indicating that the relevance judgment is the most reliable relevance judgment available. Alternatively, quality scores lower than the highest quality score may be associated with advertisements that do not have existing relevance judgments and, thus, are associated with an estimated relevance judgment. Quality scores may be indicated by any known method of assigning a score and/or a weight to an item. For instance, a numeric scale may be used such that a highest quality score is one (1) and a lowest quality score is zero (0).

An estimated relevance judgment may be determined by the determining component 223 when a relevance judgment does not exist for an advertisement. In this regard, an estimated relevance judgment may be estimated using a history of an advertiser, a history of a search query, or the like. A history of a search query may include, for example, previous advertisements that have been associated with the search query and have been associated with a relevance judgment. A history of an advertiser may include, for example, previous advertisements from the advertiser that have been associated with the search query, previous advertisements from the advertiser that have been associated with other search queries, and the like. In embodiments, the quality score is a value within a predetermined range having a highest quality score and a lowest quality score. For example, a predetermined range for a quality score is zero (0) to (1), wherein a lowest quality score is zero (0) and a highest quality score is (1) and any scores between the highest and lowest quality scores are assigned values in the range of zero (0) to one (1).

A quality score may be associated with an estimated relevance judgment that may indicate that the relevance judgment is, in fact, an estimated value. An estimated relevance judgment that is estimated based on a history of the advertiser may be associated with a higher quality score than an estimated relevance judgment that is estimated based on a history of the search query. Thus, the determining component 223 may evaluate the history of the advertiser prior to the history of the search query in order to obtain a higher quality score.

By way of example, assume that a search query is the phrase “digital camera.” A first advertisement from Kitt's Camera Store may be identified as having been previously associated with the search query and having an existing relevance judgment. Since the first advertisement has been identified as having an existing relevance judgment, it may be associated with a highest quality score indicating it is the most reliable relevance judgment available. By way of example only and not limitation, a highest quality score may be a numeric value of one (1) while a lowest quality score may be a numeric value of zero (0).

A second advertisement for Bob's Camera Shack may also be identified as an advertisement within the query:ad pair. Initially, the determining component 223 may determine whether the second advertisement has been previously associated with the search query and may have been associated with an existing relevance judgment. If the second advertisement has been previously associated with the search query and is associated with an existing relevance judgment, the existing relevance judgment may be identified by identifying component 222. If the second advertisement has not been associated with the search query, the determining component 223 may determine whether the advertiser, identified by the identifying component 222, is associated with another advertisement that has been previously associated with the search query. An advertisement different from the second advertisement that is from the same advertiser and associated with the same search query may be associated with a quality score that is lower than the highest quality score, but higher than any other quality score. In other words, an advertisement from the same advertiser associated with the same search query may be assigned a highest quality score possible, without being associated with an existing relevance judgment, that is lower than the highest quality score.

Assuming that the advertiser (i.e., Bob's Camera Shack) is associated with other advertisements that have been previously associated with the search query, an existing relevance judgment for at least one of the other advertisements can be identified, for example, by the identifying component 222. The existing relevance judgment, or variations thereof, for the at least one of the other advertisements may be used as an estimated relevance judgment for the second advertisement. Additionally, because the relevance judgment is an estimated relevance judgment, a quality score may be assigned to the second advertisement that is lower than a highest quality score but higher than any other quality score.

A third advertisement from Joe's Camera Store may also be identified as an advertisement within the query:ad pair that has been determined to not have an existing relevance judgment for the search query. For example, the advertisement may not have been previously associated with the search query. Assume that the advertiser is not associated with other advertisements that have been previously associated with the search query. In this situation, the determining component 223 determines whether the advertiser is associated with any other advertisements that have been associated with any other search query and have an existing relevance judgment. Thus, the advertiser's history is analyzed but it is no longer specific to the search query of the query:ad pair. As such, a quality score for a relevance judgment returned in this determination may be lower than the quality score for an advertisement from the same advertiser associated with the same query.

Upon determining that the advertiser is associated with at least one other advertisement that has been associated with any other search query, different from the search query of the query:ad pair, and has an existing relevance judgment, an existing relevance judgment for the at least one other advertisement is identified, for example, by the identifying component 222. The existing relevance judgment for the at least one other advertisement may be used as an estimated relevance judgment for the third advertisement. Additionally, a quality score may be assigned to the third advertisement that is lower than a highest quality score and lower than the quality score for an advertisement from the same advertiser associated with the same query.

A fourth advertisement from Electronics Surplus may also be identified as an advertisement within the query:ad pair. Assume, the fourth advertisement is determined to have not been previously associated with the search query and is not associated with an existing relevance judgment. Further assume that the advertiser is also not associated with other advertisements that have been previously associated with the search query. Further, the advertiser may not be associated with any other advertisements that have been associated with any other search queries and have an existing relevance judgment. In that situation, the determining component 223 may determine whether the search query is associated with any other advertisements having an existing relevance judgment. Thus, the search query of the query:ad pair is analyzed but it is not specific to the advertiser of the fourth advertisement. A quality score for a relevance judgment returned for this determination may be lower than the quality score for an advertisement from the same advertiser associated with any other search query.

Upon determining that the search query is associated with at least one advertisement having an existing relevance judgment, an existing relevance judgment for the at least one advertisement is identified by, for example, the identifying component 222. The existing relevance judgment for the at least one advertisement may be used as an estimated relevance judgment for the fourth advertisement. Additionally, a quality score may be assigned to the fourth advertisement that is lower than a highest quality score, lower than the quality score for an advertisement from the same advertiser associated with the same query, and lower than the quality score for an advertisement from the same advertiser associated with a different search query.

In a situation where each factor of the advertiser's history and the search query's history has been analyzed and an existing relevance judgment is not identified, a global average of all relevance judgments for all advertisements across all search queries may be identified. The global average may be identified by, for example, the identifying component 222. The global average may be used as an estimated relevance judgment and may be assigned a lowest quality score that indicates it is the least reliable relevance judgment available.

Once an estimated relevance judgment is obtained, the relevance judgments may be mapped to a real number. For example, a relevance judgment scale of +1 to −2 may be utilized such that a highest relevance judgment is +1 and a lowest relevance judgment is −2. Any numeric scale may be utilized in embodiments of the present invention.

The calculating component 224 is configured to calculate an eDCG using the relevance judgments, such as the real number mappings. The eDCG may be calculated using both the estimated relevance judgments and a positional weight of an advertisement. A positional weight, as used herein, refers generally to a value indicating a position of an advertisement. For example, a more prominent advertisement may be determined to be of higher value and, thus, be associated with a higher positional weight than a less prominent advertisement. As with the relevance judgments, the positional weights may be associated with any integer of a numerical scale.

In a specific embodiment, an eDCG may be calculated over the sum of search queries and advertisements using, for instance, the following equation:

eDCG=Σ_{q}Σₐ_{_{—}}_{qi}(eRjₐ_{_{—}}_{qi}*PW₁) Equation A

Wherein q represents a number of queries, a_qi represents the i^{th} ad for the query (q), eRJₐ_{_{—}}_{qi} represents the estimated relevance judgment for the query (q) and the i^{th} ad, and PWᵢ represents the positional weight of the i^{th} advertisement in the query (q). This provides the eDCG for the search query. As previously discussed, eRJ can, in some cases, be the global average that represents an average of all relevance judgments for all advertisements across all search queries.

In embodiments, an eDCG is calculated by the calculating component 224 for the entire advertising system by averaging the eDCG across all search queries. This differs from Equation A, which calculates the eDCG for a search query rather than the system. For instance, assuming there are fifty (50) search queries, the eDCG may be divided by the total number of search queries, which, in the present example, is fifty (50). The eDCG for the system is valuable as it provides an estimate of how the system is performing. Estimates make real-time monitoring of the DCG possible and, thus, real-time changes are available to improve the system as soon as a deficiency is detected.

Additionally, the quality scores determined by the determining component 223 may be analyzed to provide a quality of the eDCG for the system. The sum of the quality scores identified may be divided by the total number of query:ad pairs to determine a quality score of the eDCG for the system. Thus, a user will be able to identify the reliability of the eDCG for the system as it will be associated with a quality score.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other modules and/or components, and in any suitable combination and location. Various functions described herein as being performed by one or more entities may be carried out by hardware, firmware, and/or software. For instance, various functions may be carried out by a processor executing instructions stored in memory.

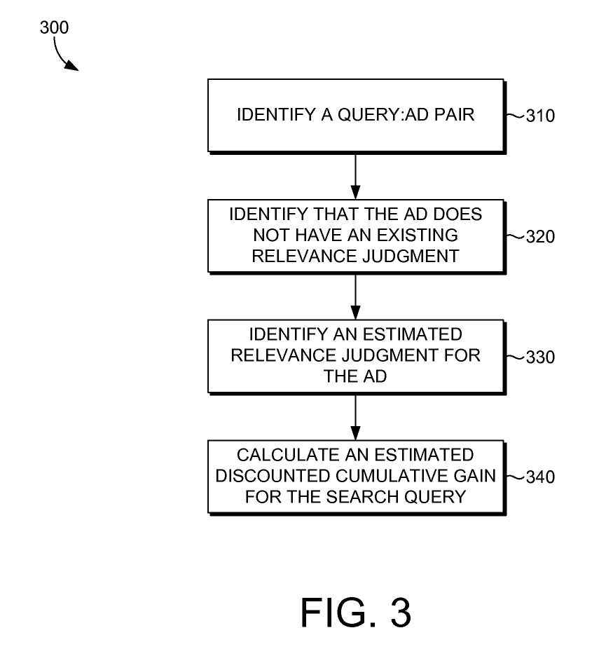

Turning now to FIG. 3, a flow diagram is illustrated which shows a first method 300 for utilizing a relevance judgment to estimate a DCG, in accordance with an embodiment of the present invention. Initially, as indicated at block 310, a query:ad pair is identified. A query:ad pair may include at least one advertisement associated with a particular search query. In embodiments, the query:ad pair may include a plurality of advertisements. At least one advertisement of the query:ad pair is identified as not having an existing relevance judgment at block 320. The advertisement may, for example, have not been previously associated with the search query. Thus, a relevance judgment of the at least one advertisement related to the search query of the query:ad pair does not exist. An estimated relevance judgment is identified at block 330. An estimated relevance judgment may be identified by evaluating a history of an advertiser, a history of a search query, or a history of a system. For instance, the advertising system 220, as illustrated in FIG. 2, may analyze (1) whether an advertiser is associated with a second advertisement that is associated with the same search query, (2) whether an advertiser is associated with any other advertisement that is associated with a different search query, (3) whether the search query is associated with any other advertisements, or (4) whether a global average of all advertisements across all search queries exists. Each of the above factors (1)-(4) may be assigned a quality score that decreases respectively. In other words, a relevance judgment for a second advertisement from the same advertiser associated with the same search (i.e., factor 1) may receive a higher quality score than a global average of relevance judgments (i.e., factor 4).

In addition to the relevance judgment, a positional weight may be assigned to the advertisement. The positional weight may depend on the position of the advertisement within a search result display. For instance, an advertisement that is in a prominent position (e.g., top and center of a display) may receive a higher positional weight than an advertisement in a less prominent position (e.g., bottom of a display).

Once an estimated relevance judgment is identified, an eDCG is calculated for the search query at block 340. An eDCG for the search query may be calculated using estimated relevance judgment(s) and the positional weight(s) corresponding to the advertisement of the query:ad pair. In embodiments, the eDCG may be calculated for a search query or for the entire advertising system.

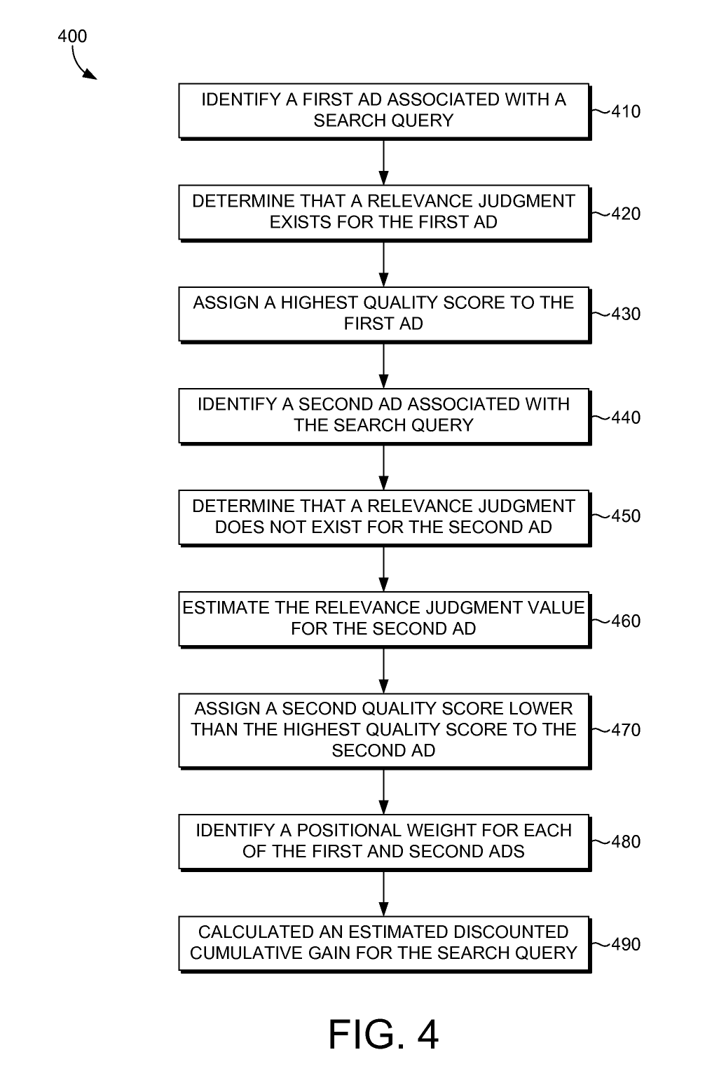

With reference to FIG. 4, a flow diagram is illustrated which shows a second method 400 for utilizing a relevance judgment to estimate a DCG, in accordance with an embodiment of the present invention. Initially, as indicated at block 410, a first advertisement associated with a search query is identified. At block 420, it is determined that a relevance judgment exists for the first advertisement relating to the search query. The first advertisement may have been previously associated with the search query and thereby has a relevance judgment in association therewith. As the relevance judgment is preexisting, a highest quality score (e.g., 1) is assigned to the first advertisement at block 430.

At block 440 a second advertisement associated with the search query is identified. It is determined at block 450 that the second advertisement is not associated with a relevance judgment and/or that the second advertisement has not previously been associated with the search query. A relevance judgment is estimated for the second advertisement at block 460. The estimated relevance judgment is associated with the second advertisement. The relevance judgment may be estimated by analyzing (1) whether an advertiser is associated with a second advertisement that is associated with the same search query, (2) whether an advertiser is associated with any other advertisement that is associated with a different search query, (3) whether the search query is associated with any other advertisements, or (4) whether a global average of all advertisements across all search queries exists.

Since the second advertisement was not associated with a preexisting relevance judgment, a quality score (e.g., 0) that is lower than the highest quality score is assigned to the second advertisement at block 470. A positional weight is identified for each of the first and second advertisements at block 480. The positional weights, the relevance judgment of the first advertisement, and the estimated relevance judgment for the second advertisement are utilized to calculate an eDCG at block 490. Each of the positional weights, the relevance judgment of the first advertisement, and the estimated relevance judgment for the second advertisement may be utilized, for example, when two advertisements are analyzed for the eDCG for the search query. Equation A detailed hereinabove illustrates that the product of the relevance judgment and the positional weight for each advertisement is summed to calculate the eDCG for a search query.

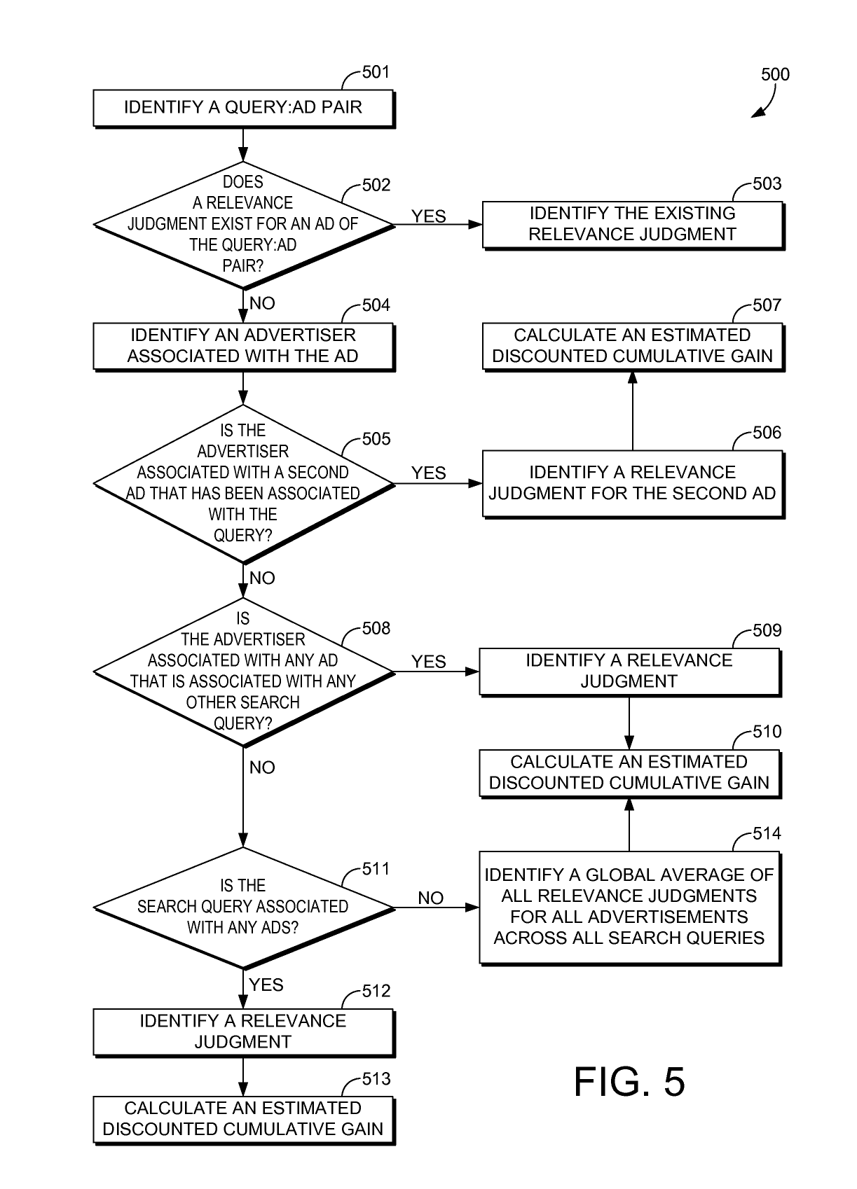

Turning now to FIG. 5, a flow diagram is illustrated which shows a method 500 for utilizing a relevance judgment to estimate a DCG, in accordance with an embodiment of the present invention. Initially, as indicated at block 501, a query:ad pair is identified. At block 502, a determination is made whether a relevance judgment exists for the advertisement of the query:ad pair. Based upon a determination that the relevance judgment already exists for the advertisement, the existing relevance judgment is identified at block 503. In such a case, the existing relevance judgment is associated with a highest quality score since the relevance judgment was preexisting and is not an estimated value.

If, however, it is determined that a relevance judgment does not exist for the advertisement of the query:ad pair, an advertiser associated with the advertisement is identified at block 504. The advertiser may be identified by, for example, the identifying component 222 of FIG. 2. Upon identifying the advertiser of the advertisement, a determination is made whether the advertiser is associated with a second advertisement that has been previously associated with the search query at block 505. Based upon a determination that the advertiser is associated with a second advertisement that has been previously associated with the search query, a relevance judgment for the second advertisement is identified at block 506. The relevance judgment for the second advertisement may be utilized to estimate a relevance judgment for the advertisement of the query:ad pair and an eDCG is calculated at block 507.

On the other hand, if it is determined that the advertiser is not associated with a second advertisement that has been previously associated with the search query, a determination is made whether the advertiser is associated with any advertisements that are associated with any other search queries at block 508. Based upon a determination that the advertiser is associated with at least one other advertisement that is associated with another search query, a relevance judgment for the at least one other advertisement is identified at block 509 and utilized to estimate a relevance judgment for the advertisement of the query:ad pair. The estimated relevance judgment may then be used to calculate the eDCG at block 510.

However, if a determination is made that the advertiser is not associated with at least one other advertisement that is associated with another search query, a determination is made whether the search query is associated with any other advertisements that have existing relevance judgments at block 511. If so, a relevance judgment is identified at block 512 and utilized to estimate a relevance judgment for the advertisement of the query:ad pair. The estimated relevance judgment is used to calculate the eDCG at block 513.

By contrast, if a determination is made that the search query is not associated with any other advertisements that have existing relevance judgments, a global average of all relevance judgments for all advertisements across all queries is identified at block 514. The global average is utilized to estimate a relevance judgment for the advertisement of the query:ad pair. The estimated relevance judgment is then used to calculate the eDCG at block 510.

It will be understood by those of ordinary skill in the art that the order of steps shown in the method 300 of FIG. 3, the method 400 of FIG. 4, and the method 500 of FIG. 5 are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media having computer-executable instructions embodied thereon that, when executed, cause a computing device to perform a method for utilizing a relevance judgment to estimate a discounted cumulative gain, the method comprising:
identifying a query:ad pair including a search query and an advertisement from an advertiser;
determining that the advertisement is not associated with a relevance judgment, wherein a relevance judgment is a value representing a relevance of the advertisement to the search query;
identifying an estimated relevance judgment for the advertisement, wherein the estimated relevance judgment is based on a history of the advertiser or a history of the search query; and
utilizing the estimated relevance judgment to calculate an estimated discounted cumulative gain for the search query.

2. The one or more computer storage media of claim 1, wherein the method further comprises identifying a positional weight for each advertisement of the query:ad pair based on a position of each advertisement.

3. The one or more computer storage media of claim 1, wherein the history of the advertiser is either the history of the advertiser with the search query or the history of the advertiser with other search queries.

4. The one or more computer storage media of claim 1, wherein the method further comprises storing the estimated discounted cumulative gain.

5. The one or more computer storage media of claim 1, wherein the method further comprises assigning a quality score to the estimated relevance judgment, wherein the quality score is less than a highest quality score.

6. The one or more computer storage media of claim 5, wherein the method further comprises identifying the quality score for the estimated discounted cumulative gain.

7. The one or more computer storage media of claim 1, wherein the method further comprises calculating an estimated discounted cumulative gain for an advertising system.

8. The one or more computer storage media of claim 7, wherein the estimated discounted cumulative gain for the advertising system is based on the estimated discounted cumulative gain for the search query and a total number of search queries.

9. The one or more computer storage media of claim 1, wherein identifying an estimated relevance judgment for the advertisement comprises identifying that the advertiser is associated with at least one other advertisement that is associated with the search query and is associated with a relevance judgment.

10. The one or more computer storage media of claim 1, wherein identifying an estimated relevance judgment for the advertisement comprises identifying that the advertiser is associated with at least one other advertisement that is associated with a relevance judgment and is not associated with the search query.

11. The one or more computer storage media of claim 1, wherein identifying an estimated relevance judgment for the advertisement comprises identifying that the search query is associated with at least one other ad that is associated with a relevance judgment.

12. The one or more computer storage media of claim 1, wherein identifying an estimated relevance judgment for the advertisement comprises identifying a global average of all relevance judgments for all advertisements associated with any search query.

13. A computerized method for utilizing a relevance judgment to estimate a discounted cumulative gain, the method comprising:
identifying a first advertisement associated with a search query;
determining that a first relevance judgment exists for the first advertisement;
identifying a second advertisement associated with the search query;
determining that a second relevance judgment does not exist for the second advertisement;
estimating the second relevance judgment for the second advertisement;
identifying a positional weight for each of the first and second advertisements; and
based on the positional weights and each of the first and second relevance judgments, calculating an estimated discounted cumulative gain for the search query.

14. The computerized method of claim 13, wherein the method further comprises:
assigning a highest quality score to the first relevance judgment, wherein the highest quality score indicates that the first relevance judgment is a realiable relevance judgment;
assigning a second quality score lower than the highest quality score to the second relevance judgment indicating that the second relevance judgment is an estimated value; and
calculating a quality score of the estimated discounted cumulative gain for the search query.

15. The computerized method of claim 14, wherein the method further comprises calculating the quality score of the estimated discounted cumulative gain for an advertising system.

16. The computerized method of claim 13, wherein the method further comprises calculating the estimated discounted cumulative gain for an advertising system.

17. The computerized method of claim 13, wherein estimating a relevance judgment for the second advertisement comprises:
identifying that an advertiser of the second advertisement is associated with a third advertisement that has been previously associated with the search query, wherein the third advertisement is further associated with a third relevance judgment that is utilized to estimate the second relevance judgment.

18. The computerized method of claim 13, wherein estimating a relevance judgment for the second advertisement comprises:
identifying that an advertiser of the second advertisement is associated with a fourth advertisement that has been previously associated with a second search query, wherein the fourth advertisement is further associated with a fourth relevance judgment that is utilized to estimate the second relevance judgment.

19. One or more computer storage media having computer-executable instructions embodied thereon that, when executed, cause a computing device to perform a method for utilizing a relevance judgment to estimate a discounted cumulative gain, the method comprising:
identifying a query:ad pair including a search query and a first advertisement from an advertiser;
identifying that the first advertisement has not previously been associated with the search query prior to being identified as the first advertisement of the query:ad pair;
determining whether the advertiser is associated with a second advertisement that has been associated with the search query;
upon determining that the advertiser is not associated with the second advertisement that has been associated with the search query, determining whether the advertiser is associated with a third advertisement that is associated with another search query and has a relevance judgment associated therewith;
upon determining that the advertiser is not associated with a third advertisement that is associated with another search query and has the relevance judgment associated therewith, determining whether a fourth advertisement from another advertiser is associated with the search query and is associated with an alternative relevance judgment;
upon determining that the fourth advertisement from another advertiser is not associated with the search query and is not associated with the alternative relevance judgment, identifying an average of relevance judgments for each advertisement having any relevance judgment that is associated with any search query; and
based on the average of relevance judgments for each advertisement having any relevance judgment that is associated with any search query, calculating an estimated discounted cumulative gain.

20. The one or more computer storage media of claim 19, wherein the method further comprises calculating a quality score of the estimated discounted cumulative gain.
